(19) United States
(12) Patent Application Publication
(10) Pub. No.: US 2023/0346042 A1
(43) Pub. Date: Nov. 2, 2023

(54) AEROSOL PROVISION DEVICE, AEROSOL GENERATING ARTICLE AND AEROSOL PROVISION SYSTEM

(71) Applicant: Nicoventures Trading Limited, London (GB)

(72) Inventors: Patrick Moloney, London (GB); Justin Han Yang Chan, London (GB); Anton Korus, London (GB)

(21) Appl. No.: 17/800,666

(22) PCT Filed: Feb. 11, 2021
(86) PCT No.: PCT/GB2021/050328

§ 371 Date: Aug. 18, 2022

(30) Foreign Application Priority Data
Feb. 18, 2020 (GB) 2002211.7

(51) Int. Cl. A24F 40/53; A24F 40/51; A24F 40/46; A24D 1/20

(52) U.S. Cl. CPC A24F 40/53; A24F 40/51; A24F 40/46; A24D 1/20

(57) ABSTRACT

An aerosol provision device includes a receptacle configured to receive an article comprising an aerosolizable medium, an emitter configured to emit electromagnetic radiation into the receptacle and a receiver configured to receive the electromagnetic radiation after interaction with an article in the receptacle. The device further includes control electronics configured to determine at least one characteristic of the article based on a spatial property of the electromagnetic radiation received by the receiver.

### PRIORITY CLAIM

The present application is a National Phase entry of PCT Application No. PCT/GB2021/050328, filed Feb. 11, 2021, which claims priority from GB Application No. 2002211.7, filed Feb. 18, 2020, each of which is hereby fully incorporated herein by reference.

### TECHNICAL FIELD

The present disclosure relates to an aerosol provision device, an article for use in an aerosol provision device and an aerosol provision system.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

According to a first aspect of the present disclosure, there is provided an aerosol provision device comprising a receptacle configured to receive an article comprising an aerosolizable medium, an emitter configured to emit electromagnetic radiation into the receptacle and a receiver configured to receive the electromagnetic radiation after interaction with an article in the receptacle. The device further comprises control electronics configured to determine at least one characteristic of the article based on a spatial property of the electromagnetic radiation received by the receiver.

According to a second aspect of the present disclosure, there is provided an article comprising an aerosolizable medium and a component arranged at an outer surface of the article, wherein the component is configured to interact with electromagnetic radiation to change a spatial property of the electromagnetic radiation.

According to a third aspect of the present disclosure, there is provided a system comprising an aerosol provision device according to the first aspect, and an article according to the second aspect.

### BRIEF DESCRIPTION OF THE DRAWINGS

Further features and advantages of the disclosure will become apparent from the following description of preferred embodiments of the invention, given by way of example only, which is made with reference to the accompanying drawings.

FIG. 1 shows a perspective view of an example of an aerosol provision device.

FIG. 2 shows a top view of the example aerosol provision device of FIG. 1.

FIG. 3 shows a diagrammatic representation of a cross-sectional view of the example aerosol provision device of FIG. 1.

FIG. 4 shows a diagrammatic representation of a first example arrangement to determine at least one characteristic of an article based on a reflection angle of electromagnetic radiation.

FIG. 5 shows a diagrammatic representation of a second example arrangement to determine at least one characteristic of an article based on a reflection angle of electromagnetic radiation.

FIG. 6 shows a diagrammatic representation of a third example arrangement to determine at least one characteristic of an article based on a reflection angle of electromagnetic radiation.

FIG. 7 shows a diagrammatic representation of a close-up of a portion of FIG. 6.

FIG. 8 shows a diagrammatic representation of a fourth example arrangement to determine at least one characteristic of an article based on an intensity distribution of electromagnetic radiation.

FIG. 9 shows a diagrammatic representation of a electromagnetic radiation undergoing diffraction.

FIG. 10 shows a diagrammatic representation of a fifth example arrangement to determine at least one characteristic of an article based on an intensity distribution of electromagnetic radiation.

FIG. 11 shows a diagrammatic representation of a sixth example arrangement to determine at least one characteristic of an article based on a polarization state of electromagnetic radiation.

FIG. 12 shows a diagrammatic representation of a seventh example arrangement comprising alignment features.

FIG. 13 shows a diagrammatic representation of an eighth example arrangement comprising alignment features.

### DETAILED DESCRIPTION OF THE DRAWINGS

A first aspect of the present disclosure defines an aerosol provision device comprising a receptacle which can receive an article comprising an aerosolizable medium, such as tobacco, for heating. A user may insert the article into the aerosol provision device before it is heated to produce an aerosol, which the user subsequently inhales. The article may be, for example, of a predetermined or specific size that is configured to be placed within the receptacle which is sized to receive the article. In one example, the article is tubular in nature, and may be known as a “tobacco stick”, for example, the aerosolizable medium may comprise tobacco formed in a specific shape which is then coated, or wrapped in one or more other materials, such as paper or foil. In another example, the article may be a flat substrate. The aerosolizable medium may also be known as smokable material or an aerosolizable material. The aerosol provision device may also be known as an aerosol generating apparatus.

It may be desirable for the device to be able to identify or recognize the particular article that has been introduced into the device by determining at least one characteristic of the article. For example, the device may be optimized for a particular type of article (e.g. one or more of size, shape, particular aerosolizable material, etc.). It may be undesirable for the device to be used with an article having different properties. If the device could identify or recognize the particular article, or at least the general type of article, that has been introduced into the device, this can help eliminate or at least reduce counterfeit or other non-genuine articles being used with the device. In addition, it may be desirable to identify the particular article so that the device can be operated in a manner suitable for the particular article. For example, a specific heating temperature, heating profile or heating length may be selected responsive to the specific article introduced into the receptacle. Counterfeit articles may include inferior aerosolizable materials which can damage the device, and/or reduce user satisfaction; if an article introduced into the receptacle is not known or the device may be prevented from heating, for example by disabling a heater in the device.

The example articles described herein can make it more difficult for counterfeit articles to be produced because they include a component which interacts with electromagnetic radiation to change a spatial property of the electromagnetic radiation which can be measured so as to identify the article. An emitter in the device emits the electromagnetic radiation onto the article, and a receiver receives the electromagnetic radiation from the article once the spatial property has been changed by interaction with the component. The specific dimensions and features of the component can be difficult to deduce and replicate without the use of specialized equipment, improving security and making counterfeiting more difficult.

An example aerosol provision device described herein comprises a receptacle configured to receive an article comprising an aerosolizable medium, an emitter configured to emit electromagnetic radiation into the receptacle, a receiver configured to receive the electromagnetic radiation after interaction with an article in the receptacle, and control electronics configured to determine at least one characteristic of the article based on a spatial property of the electromagnetic radiation received by the receiver.

By providing control electronics which determine a spatial property of received electromagnetic radiation, a characteristic of the article can be deduced. For example, the type of article or the type of aerosolizable material can be determined based on the measured spatial property of the radiation. In one example, a look-up table is used to determine the at least one characteristic of the article once the spatial property has been determined.

The spatial property may be an angle at which the electromagnetic radiation is received by the receiver. For example, the receiver and/or control electronics may be used to determine the angle at which the electromagnetic radiation is received by the receiver. Thus, each article may be configured to cause the electromagnetic radiation to be deflected by a certain amount to cause the radiation to be received at a specific angle. An article of a different type may deflect the electromagnetic radiation by a different amount. Accordingly, the angle at which the electromagnetic radiation is received can be used as a signature to identify the article.

The receiver may comprise an image sensor and the control electronics are configured to determine, based on the received electromagnetic radiation at the image sensor, the angle at which the electromagnetic radiation is received. Thus, a single image sensor may be able to detect one or more different angles of received electromagnetic radiation. By using a single sensor, the device may be more compact, lighter and/or cheaper to manufacture.

The image sensors described herein may detect electromagnetic radiation of any wavelength, such as visible, infra-red or ultraviolet. An image sensor may be a CCD or CMOS sensor, for example.

The receiver may comprise a plurality of image sensors and the control electronics are configured to determine, based on which of the plurality of image sensors receive the electromagnetic radiation, the angle at which the electromagnetic radiation is received. This is because certain image sensors are illuminated depending upon the angle of the incident radiation. This method can provide a simple way to determine the angle, by examining which of the plurality of image sensors experience the greatest intensity. Thus, multiple image sensors can be used to determine the angle of the received electromagnetic radiation. An example image sensor is a photodiode. A plurality of photodiodes, such as a two-dimensional array, can form part of a Complementary Metal Oxide Semiconductor (CMOS) image sensor or a Charge Coupled Device (CCD) image sensor.

In one example, the plurality of sensors are arranged at different positions within the device, and the article causes the electromagnetic radiation to be deflected towards one of the sensors depending upon how the article is constructed and arranged. For example, a first article may comprise a reflection surface orientated at a first angle which causes the radiation to be received by a first sensor. A second article may comprise a reflection surface orientated at a second, different, angle which causes the radiation to be received by a second sensor. Thus, the angle at which the electromagnetic radiation is received can be determined based on which of the plurality of image sensors receives the electromagnetic radiation.

In another example, each image sensor of the plurality of image sensors comprises a filter configured to pass electromagnetic radiation which has a threshold angle of incidence. For example, electromagnetic radiation may be incident upon the plurality of image sensors at a particular angle from the axis perpendicular to the sensor (known as the angle of incidence). A first filter (having a first threshold or range of angle of incidence) is positioned above a first image sensor and filters out the electromagnetic radiation so that the first image sensor only detects electromagnetic radiation of a predetermined angle of incidence or range of angles of incidence, for example angles of incidence about ±5°, ±10°, ±15° or ±20° of a first predetermined angle of incidence. A second filter (with a second, different, threshold or range of angle of incidence) is positioned above a second image sensor and filters out the electromagnetic radiation so that the second image sensor only detects electromagnetic radiation of a predetermined angle of incidence or range of angles of incidence, for example angles of incidence about ±5°, ±10°, ±15° or ±20° of a second predetermined angle of incidence. Thus, based on which image sensor detects electromagnetic radiation, the angle at which the electromagnetic radiation is received can be determined. The threshold may be a range of angles in some examples.

The spatial property may be an intensity distribution of the electromagnetic radiation. For example, the receiver and/or control electronics may be used to determine the intensity distribution of the received radiation. Thus, each article may be configured to cause the electromagnetic radiation to be scattered/diffracted to produce a specific intensity distribution. An article of a different type may produce a different intensity distribution. Accordingly, the intensity distribution can be used as a signature to identify the article. The intensity distribution may be a diffraction pattern, for example.

The receiver may comprise an image sensor and the control electronics are configured to determine, based on the received electromagnetic radiation at the image sensor, the intensity distribution. Thus, a single image sensor may be able to detect the intensity distribution. By using a single sensor, the device may be more compact, lighter and/or cheaper to manufacture.

In one example, the image sensor comprises a plurality of photodiodes and the control electronics are configured to determine, based on intensity measurements recorded by the plurality of photodiodes, the intensity distribution. For example, the image sensor may comprise an array of photodiodes and certain photodiodes receive a greater intensity of electromagnetic radiation than other photodiodes. Based on these intensity measurements, the intensity distribution can be determined. For example, the spacing between high intensity measurements may be used as a signature to identify the article. In another example, the number or count of high intensity maxima may be used to identify the article. In a further example, a ratio of intensities between individual ones of the high intensity maxima may be used to identify the article.

In one example, the receiver comprises a plurality of image sensors and the control electronics are configured to determine, based on an intensity of the electromagnetic radiation received by each of the plurality of image sensors, the intensity distribution. Thus, multiple image sensors can be used to determine the intensity distribution. Some image sensors may detect a greater intensity of electromagnetic radiation when compared to other image sensors. Based on these intensity measurements, the intensity distribution can be determined.

The spatial property may be a polarization state of the electromagnetic radiation. For example, the receiver and/or control electronics may be used to determine the polarization state of the electromagnetic radiation received by the receiver. Thus, an article may be configured to change the polarization state of the electromagnetic radiation from a first polarization state to a second polarization state. An article of a different type may change the first polarization state to a third polarization state. Accordingly, the polarization state can be used as a signature to identify the article.

The emitter may emit electromagnetic radiation having an initial polarization state, such as a circular polarization, a linear polarization, an elliptical polarization or no polarization, for example. The polarization state may further have a defined direction, such as left/right hand circular polarization, vertically/diagonally/horizontally linearly polarization, etc. Electromagnetic radiation with no polarization means that the electromagnetic radiation has no well-defined polarization.

The receiver may comprise a sensor and the control electronics are configured to determine, based on the received electromagnetic radiation, the polarization state. Thus, a single sensor may be able to differentiate between different polarizations.

The sensor may be an image sensor, for example. In one example, the image sensor comprises a plurality of photodiodes each having an associated polarization filter. The control electronics are configured to determine, based on which of the plurality of photodiodes receive the electromagnetic radiation, the polarization state. Thus, certain photodiodes may only detect electromagnetic radiation if the associated polarization filter allows that particular polarization state to pass through. For example, electromagnetic radiation may be incident upon the plurality photodiodes with a first polarization state. A first polarization filter may allow the electromagnetic radiation to pass through so that a first photodiode detects the electromagnetic radiation, and a second polarization filter may block, reflect and/or absorb the electromagnetic radiation so that a second photodiode does not detect the electromagnetic radiation. Thus, based on which photodiode detects electromagnetic radiation, the polarization state can be determined.

The receiver may comprise a plurality of sensors each configured to receive electromagnetic radiation of a particular polarization state, and the control electronics are configured to determine, based on an intensity of the electromagnetic radiation received by each of the plurality of sensors, the polarization state. For example, each sensor may comprise a polarization filter to allow the sensor to receive radiation of a particular polarization in the same way as described above for the photodiodes of the single sensor. Using multiple sensors may be cheaper to produce when compared to individual photodiode polarization filters. However, by using a single sensor, the device may be more compact and/or lighter.

The aerosol provision device may further comprise a heating assembly, and the control electronics are configured to operate the heating assembly based on the determined at least one characteristic of the article. Accordingly, a particular heating profile, heating temperature, and/or duration of heating can be provided depending upon the type of article detected.

The aerosol provision device may further comprise an alignment feature to ensure that the article is received within the receptacle at a predetermined orientation relative to the emitter. Accordingly, the alignment feature ensures that a user inserts the article correctly so that the emitter can emit the radiation onto the article at the correct position. If the article is incorrectly orientated, the receiver may not receive any electromagnetic radiation, or the control electronics may incorrectly determine the least one characteristic of the article. For example, a misaligned article may cause the electromagnetic radiation to be received by the receiver at a different angle to what is intended.

As briefly mentioned above, an example aerosol-generating article comprises an aerosolizable medium and a component arranged at an outer surface of the article, wherein the component is configured to interact with electromagnetic radiation to change a spatial property of the electromagnetic radiation. Thus, the component can cause the electromagnetic radiation to have a certain spatial property, which can be detected by the receiver of the device. The spatial property can be used as a signature to identify the article.

The component may comprise a reflecting surface orientated at predetermined angle, and the spatial property may be an angle at which the electromagnetic radiation is deflected by the reflecting surface. Thus, the article comprises a reflecting surface, which causes the electromagnetic radiation to be received at a particular angle by the receiver. By changing the spatial property, the reflecting surface is configured to alter the trajectory of the electromagnetic radiation emitted by the emitter by causing the radiation to be reflected.

The reflecting surface may substantially flat (i.e. two-dimensional). The reflecting surface may be at least partially concave so as to at least partially focus incident electromagnetic radiation. In some examples, a portion of the reflecting surface reflects the electromagnetic radiation. The reflecting surface may form an alignment feature (to cooperate with a corresponding alignment feature of the device) to ensure that the article is inserted into the receptacle in a particular orientation.

The reflecting surface may form at least a portion of the outer surface of the article. For example, at least a portion of the outer surface of the article may be provided with a reflective material or coating.

The component may further comprise a transparent surface through which the electromagnetic radiation can pass, and the transparent surface forms at least a portion of the outer surface of the article. The reflecting surface is positioned inwardly of the transparent surface. Thus, the reflecting surface may be arranged closer to the center of the article than the transparent surface. Incident electromagnetic radiation can pass through the transparent surface, reflect from the reflecting surface, and pass back through the transparent surface (or pass through another transparent surface) before being received by the receiver.

The transparent surface may be flat or curved or may extend around a corner of the article. The transparent surface may form an alignment feature.

The spatial property may be an intensity distribution of the electromagnetic radiation, and the component may comprise a grating surface configured to change the intensity distribution of the electromagnetic radiation. For example, the electromagnetic radiation emitted by the emitter may have a first intensity distribution and the grating surface is configured to interact with the radiation to change the intensity distribution to a second intensity distribution. The intensity of an electromagnetic wave may be defined as the power per unit area.

The first intensity distribution may be a point-like intensity distribution, for example. The second intensity distribution may be a diffraction pattern, for example, where the pattern comprises high and low intensity regions. The grating may therefore be a diffraction grating. The diffraction grating may be reflective or transmissive. The grating surface may be orientated at a predetermined angle.

The component may also comprise a transparent surface, through which the electromagnetic radiation can pass, and the transparent surface forms at least a portion of the outer surface of the article and the grating surface is positioned inwardly of the transparent surface.

The grating surface may comprise one or more slits or grooves to split and diffract the electromagnetic radiation into a plurality of beams traveling in different directions to generate an intensity distribution of a specific form. The grating surface may alternatively comprise one or more raised protrusions to scatter and diffract the electromagnetic radiation. The features of the grating surface, and in particular the precise spacing between these features, causes the intensity distribution to have a predetermined pattern. The spacings are small in nature, which may make it difficult for potential counterfeiters to replicate.

In a particular example, the component forms at least a portion of the outer surface of the article, and the component has a predetermined surface roughness to form the grating surface. For example, the outer surface of the article may be provided by a wrapping material, such as paper, and at least a portion of the wrapping material may form the grating surface. These materials can be relatively inexpensive to produce.

The spatial property may be a polarization state of the electromagnetic radiation, and the component may comprise a polarization element configured to change the polarization state of the electromagnetic radiation.

The emitter may emit electromagnetic radiation having a first polarization state, such as a circular polarization, a linear polarization, an elliptical polarization or no polarization, and the polarization element is configured to change the polarization state to a second polarization state.

In one example, the polarization element is a lens or filter. In an example, the polarization element may be a linear filter which only allows radiation having a predetermined linear polarization to pass through. If the radiation was initially unpolarized, the radiation would be linearly polarized after passing through the linear filter. In another example, the polarization element may be a circular filter which only allows radiation having a predetermined circularly polarization to pass through. If the radiation was initially unpolarized or was linearly polarized, the radiation would be circularly polarized after passing through the circular filter.

The outer surface of the article may comprise an alignment feature to ensure that the article is positioned within an aerosol provision device at a predetermined orientation. The alignment feature of the article may interact with a corresponding alignment feature of the device.

In one example, the alignment feature is a visual marker to inform the user how to insert the article rather than being a physical feature which limits the insertion. In other example, the article may have a certain profile to ensure the user inserts the article correctly. In one example, the article has an asymmetric outer profile.

The electromagnetic radiation may be monochromatic or polychromatic. Thus, the emitter and/or receiver may be configured to emit and receive monochromatic or polychromatic radiation.

The receiver may comprise the control electronics, or some components of the control electronics. Alternatively, the control electronics may be separate from the receiver. The control electronics may be a controller, such as a processor, for example.

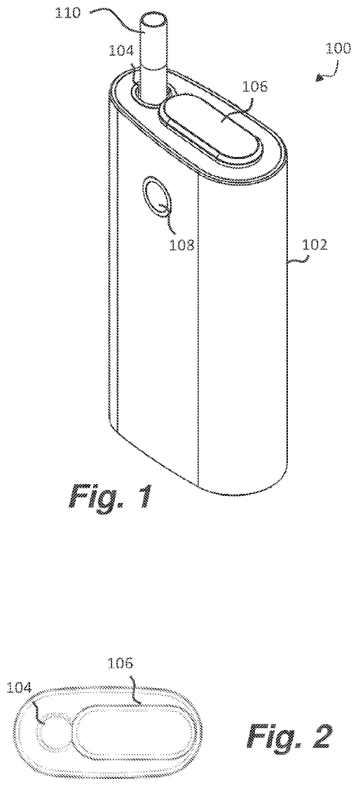

FIG. 1 shows an exemplary device 100 for generating aerosol from an aerosolizable medium. The device 100 may be known as an aerosol provision device. In broad outline, the device 100 may be used to heat a replaceable article 110 comprising an aerosolizable medium, to generate an aerosol or other inhalable medium which is inhaled by a user of the device 100. FIG. 2 shows a top view of the device 100.

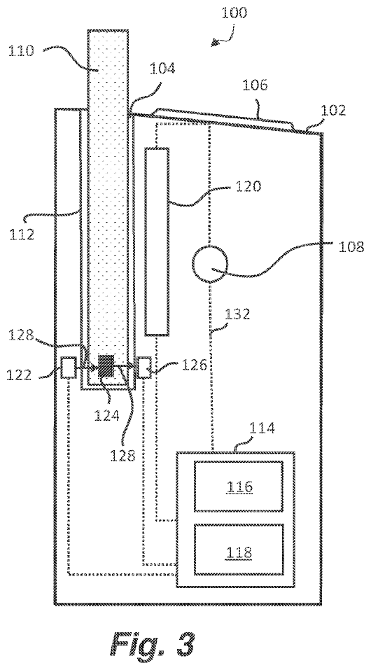

The device 100 comprises a housing 102 which houses the various components of the device 100. The housing 102 has an opening 104 in one end, through which the article 110 may be inserted into a receptacle, cavity or chamber. In use, the article 110 may be fully or partially inserted into the receptacle. The receptacle may be heated by a heating assembly (shown in FIG. 3). The device 100 may also comprise a lid, or cap 106, to cover the opening 104 when no article is in place. In FIGS. 1 and 2, the cap 106 is shown in an open configuration, however the cap 106 may move, for example by sliding, into a closed configuration.

The device 100 may include a user-operable control element 108, such as a button or switch, which operates the device 100 when pressed. In use, when the device 100 is switched on using the button 108, power from a power source (such as a battery within the device 100) is supplied to various components of the device, such as the heating assembly, so that the article 110 is heated and a flow of aerosol is generated.

FIG. 3 shows a diagrammatic representation of a cross-sectional view of the device 100 shown in FIG. 1. The device 100 has a receptacle, or chamber 112 which is configured to receive an article 110 to be heated. In one example, the receptacle 112 is generally in the form of a hollow cylindrical tube into which an article 110 comprising aerosolizable medium is inserted for heating in use. However, different arrangements for the receptacle 112 are possible. In the example of FIG. 3, an article 110 comprising aerosolizable medium has been inserted into the receptacle 112. The article 110 in this example is an elongate cylindrical rod, although the article 110 may take any suitable shape. In this example, an end of the article 110 projects out of the device 100 through the opening 104 of the housing 102 such that user may inhale the aerosol through the article 110 in use. The end of the article projecting from the device 100 may include a filter material. In other examples, the article 110 is fully received within the receptacle 112 such that it does not project out of the device 100. In such a case, the user may inhale the aerosol directly from the opening 104, or via a mouthpiece which may be connected to the housing 102 around the opening 104.

The device 100 comprises one or more aerosol generating elements. In one example, the aerosol generating elements are in the form of a heater assembly 120 arranged to heat the article 110 located within the receptacle 112. In one example the heater assembly 120 comprises resistive heating elements that heat up when an electric current is applied to them. In other examples, the heater assembly 120 may comprise a susceptor material that is heated via induction heating. In the example of the heater assembly 120 comprising a susceptor material, the device 100 also comprises one or more induction elements which generate a varying magnetic field that penetrate the heater assembly 120. The heater assembly 120 may be located internally or externally of the receptacle 112 or article 110. In one example, the heater assembly 120 may comprise a thin film heater that is wrapped around an external surface of the receptacle 112. For example, the heater assembly 120 may be formed as a single heater or may be formed of a plurality of heaters aligned along the longitudinal axis of the receptacle 112. The receptacle 112 may be annular or tubular, or at least part-annular or part-tubular around its circumference. In one particular example, the receptacle 112 is defined by a stainless steel support tube. The receptacle 112 is dimensioned so that substantially the whole of the aerosolizable medium in the article 110 is located within the receptacle 112, in use, so that substantially the whole of the aerosolizable medium may be heated. The receptacle 112 may be arranged so that selected zones of the aerosolizable medium can be independently heated, for example in turn (over time) or together (simultaneously), as desired.

In some examples, the device 100 includes electronics 114 that comprises control electronics 116, such as a controller, and a power source 118, such as a battery. The control electronics 116 may include a processor arrangement, which, among other things, is configured to identify the article 110 introduced into the receptacle 112, which will be described in more detail below.

The power source 118 may be, for example, a battery, such as a rechargeable battery or a non-rechargeable battery. Examples of suitable batteries include, for example, a lithium-ion battery, a nickel battery (such as a nickel-cadmium battery), an alkaline battery and/or the like. The battery is electrically coupled to the one or more heaters to supply electrical power when required and under control of the control electronics 116 to heat the aerosolizable medium without causing the aerosolizable medium to combust. Locating the power source 118 adjacent to the heater assembly 120 means that a physically large power source 118 may be used without causing the device 100 as a whole to be unduly lengthy. As will be understood, in general, a physically large power source 118 has a higher capacity (that is, the total electrical energy that can be supplied, often measured in Amp-hours, Watt-hours or the like) and thus the battery life for the device 100 can be longer.

As mentioned above, it is sometimes desirable for the device 100 to be able to identify or recognize the particular article 110 that has been introduced into the device 100. For example, the device 100, including, in particular, the heating control provided by the control electronics 116, will often be optimized for a particular arrangement of the article 110.

Accordingly, the device 100 includes an emitter 122 and a receiver 126 spaced apart from the emitter 122. The emitter 122 is configured to emit electromagnetic radiation 128 into the receptacle 112 and the receiver is configured to receive the electromagnetic radiation 128 after interaction with the article 110 in the receptacle 112.

The article 110 comprises a component 124 that is configured to interact with electromagnetic radiation 128 to change a spatial property of the electromagnetic radiation 128. How the component 124 changes the spatial property will be dependent upon the specific component 124 present in the article 110.

The receiver 126, in combination with the control electronics, is configured to detect and analyze the received electromagnetic radiation to determine the spatial property, which is used as a signature to determine at least one characteristic of the article 110. Thus, the characteristics of the article 110 can be determined based on the determined spatial property. In this way, the device 110 can identify the article 110 to confirm the article 110 is genuine and/or provide a specific heating profile 110 tailored to the article 110.

The spatial property may include the angle at which the electromagnetic radiation is received by the receiver (or the angle at which the electromagnetic radiation is deflected by the component 124), an intensity distribution of the electromagnetic radiation, or a polarization state of the electromagnetic radiation. The component 124 therefore interacts with the received electromagnetic radiation and alters a spatial property of the electromagnetic radiation.

The control electronics 116 are configured to receive a signal from the receiver 126. The control electronics 116 may also receive a signal from the button 108 and activate the heater assembly 120 in response to the received signal from the receiver 126. The control electronics 116 may also be configured to send a signal to the emitter 122 to cause the emitter to emit electromagnetic radiation 128 into the receptacle 112. In other examples, the emitter 122 may emit the electromagnetic radiation 128 without instruction from the control electronics 116. Electronic elements within the device 100 may be electrically connected via one or more connecting elements 132, shown depicted as dashed lines.

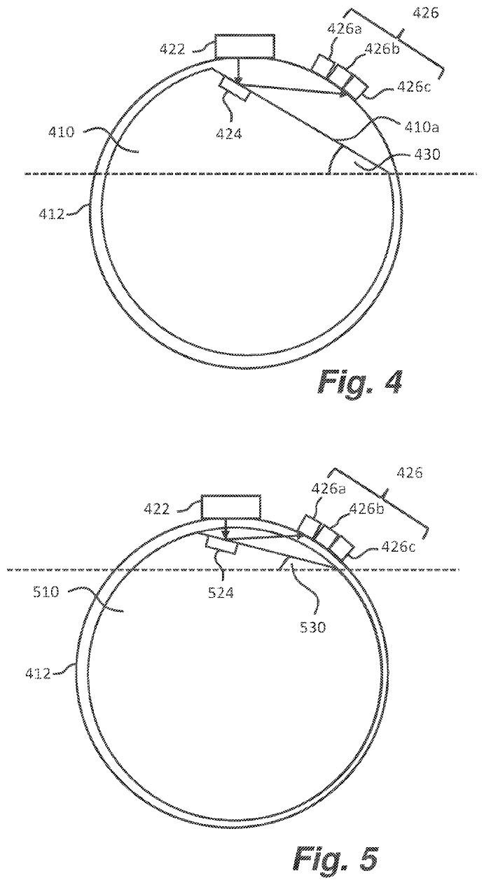

FIG. 4 depicts a first example arrangement to determine at least one characteristic of an article 410 based on a spatial property of electromagnetic radiation. FIG. 4 shows a top down view of the article 410 inserted into the device 100.

The device 100 comprises an emitter 422, a receiver 426, and a receptacle 412. The receiver 426 comprises a plurality of image sensors, including a first image sensor 426a, a second image sensor 426b and a third image sensor 426c. In this example there are three image sensors, however it will be appreciated that the receiver 426 may comprise two or more image sensors. In this example the plurality of image sensors are arranged circumferentially around the receptacle 412, however in other examples the plurality of image sensors may be arranged vertically, along a longitudinal axis of the receptacle 412. The receiver 426 may be communicably coupled to the control electronics 116 of the device 100 (shown in FIG. 3).

The article 410 comprises a component 424 arranged along an outer surface 410a of the article. In this example, the component 424 is a substantially flat reflecting surface 424 orientated at predetermined angle 430. Because the plurality of image sensors are arranged circumferentially around the receptacle 412, the angle 430 is an azimuth angle. In examples where the plurality of image sensors are arranged vertically, the reflecting surface 424 may be orientated with respect to the longitudinal axis of the receptacle 412.

The reflecting surface 424 is arranged to reflect incident electromagnetic radiation at a predetermined angle so that it is received by the receiver 426 at a particular angle with respect to the receiver 426. In this example, the reflecting surface 424 is orientated by a particular angle 430, which causes the electromagnetic radiation to be deflected towards the third image sensor 426c. Thus, the component 424 interacts with the electromagnetic radiation to change the trajectory of the electromagnetic radiation. The receiver 426 therefore receives electromagnetic radiation from a particular direction.

If the reflecting surface 424 had been orientated at a different angle the third image sensor 426c may not have received electromagnetic radiation (or may have received a lower intensity of the electromagnetic radiation). FIG. 5 shows an example in which another article 510 is inserted into the same device of FIG. 4. The article 510 comprises a reflecting surface 524 orientated at different angle 530, which is smaller than angle 430. Accordingly, the reflecting surface 524 causes the indecent electromagnetic radiation to be deflected by a different amount when compared to the reflecting surface 424 of FIG. 4, such that the electromagnetic radiation is received by the first image sensor 426a. Thus, the angle at which the electromagnetic radiation is received/deflected can be determined based on which of the plurality of image sensors receives the highest intensity of the reflected electromagnetic radiation.

In a particular example, the receiver 426 measures the intensity of electromagnetic radiation received by each of the plurality of image sensors and sends sensor data to the control electronics 116 of the device 100. From the sensor data, the control electronics can determine or deduce the angle at which the electromagnetic radiation is received by the receiver, and therefore can infer the angle 430, 530 at which the reflecting surface 424, 524 is orientated. Thus, the control electronics can identify the article 410, 510 in the receptacle 412 based on a spatial property of the electromagnetic radiation.

In a similar example (not depicted), each image sensor of the plurality of image sensors may comprise a filter which allows electromagnetic radiation to pass through if it has a particular threshold angle of incidence. For example, the first image sensor 426a may comprise a first filter which allows electromagnetic radiation to pass through if it has an angle of incidence substantially equal to (or less than) a first threshold angle. The second image sensor 426b may comprise a second, different, filter which allows electromagnetic radiation to pass through if it has an angle of incidence substantially equal to (or less than) a second threshold angle. The third image sensor 426c may comprise a third, different, filter which allows electromagnetic radiation to pass through if it has an angle of incidence substantially equal to (or less than) a third threshold angle.

In such an arrangement, the emitter may be configured to emit a wide beam of electromagnetic radiation such that reflected electromagnetic radiation is incident upon the first, second and third filters. Depending upon the angle at which the reflecting surface is orientated, the electromagnetic radiation will have a particular angle of incidence upon the first, second and third filters. However, not all of the filters may have a threshold angle which allows the radiation to pass through and be received by the corresponding image sensor. Thus, some of the filters may filter out the electromagnetic radiation so that the corresponding image sensors will detect no, or little, electromagnetic radiation. Accordingly, the angle at which the electromagnetic radiation is received/deflected can be determined based on which of the plurality of image sensors receives the highest intensity of the reflected electromagnetic radiation.

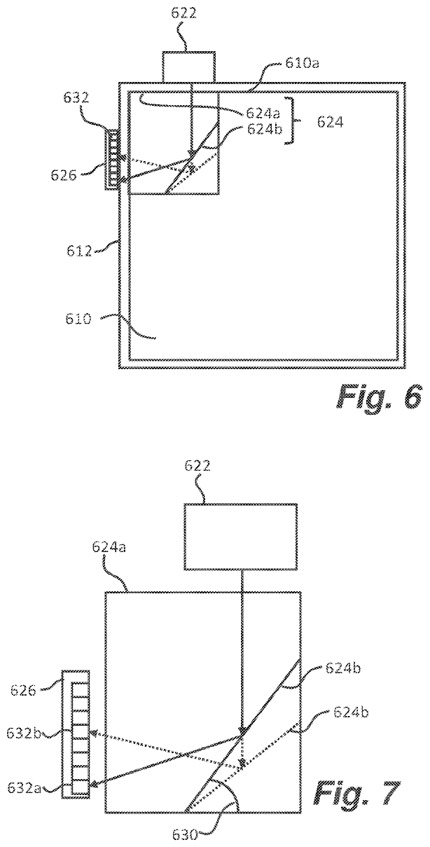

FIG. 6 depicts a second example arrangement to determine at least one characteristic of an article 610 based on a spatial property of electromagnetic radiation. FIG. 6 shows a top down view of the article 610 inserted into the device 100. In this example, the article 610 has a substantially square-shaped cross section. FIG. 7 shows a close-up of a portion of FIG. 6.

The device 100 comprises an emitter 622, a receiver 626, and a receptacle 612. The receiver 626 comprises a single image sensor which comprises a plurality of photodiodes 632. In this example the emitter 622 and the receiver 626 are arranged around a longitudinal axis the receptacle 612, however, in other examples they may be arranged vertically along the longitudinal axis of the receptacle 612. The receiver 626 may be communicably coupled to the control electronics 116 of the device 100 (shown in FIG. 3).

The article 610 comprises a component 624 arranged at an outer surface 610a of the article 610. In this example, the component 624 comprises a transparent surface 624a which extends in two dimensions around a corner of the article 610. The transparent surface 624a is made of a material, such as plastic, through which electromagnetic radiation can pass. The transparent surface 624a forms a portion of the outer surface 610a of the article 610. The component 624 further comprises a reflecting surface 624b which is positioned inwardly of the transparent surface 624a. The electromagnetic radiation can pass through the transparent surface 624a, reflect from the reflecting surface 624b, and pass back through the transparent surface 624a.

The reflecting surface 624b is arranged to reflect incident electromagnetic radiation by predetermined amount so that it is received by the receiver 626 at a particular angle with respect to the receiver 626. The reflecting surface 624b is orientated by a particular angle 630, which causes the electromagnetic radiation to be deflected towards a particular photodiode 632. The reflection of the electromagnetic radiation from the reflecting surface 624b is shown depicted as solid arrows.

If the reflecting surface had been orientated at a different angle, a different photodiode would have received the electromagnetic radiation (or may have received a higher intensity of the electromagnetic radiation). FIGS. 6 and 7 show how the trajectory of the electromagnetic radiation would have been different if the reflecting surface 624b had been arranged at a different, smaller, angle. The dashed lines depict a differently orientated reflecting surface and the resulting trajectory of the electromagnetic radiation.

Because the angle is different in this alternative arrangement, a higher intensity of the electromagnetic radiation is received by a different photodiode. FIG. 7 therefore shows a first photodiode 632a receiving the highest intensity of electromagnetic radiation when the reflecting surface 624b is arranged in a first orientation (shown as solid lines) and a second photodiode 632b receiving the highest intensity of electromagnetic radiation when the reflecting surface 624b is arranged in a second orientation (shown as dashed lines). Thus, the angle at which the electromagnetic radiation is received/deflected can be determined based on which of the plurality of photodiodes receives the highest intensity of the reflected electromagnetic radiation.

In a particular example, the receiver 626 measures the intensity of electromagnetic radiation received by each of the plurality of photodiodes and sends sensor data to the control electronics 116 of the device 100. From the sensor data, the control electronics can determine or deduce the angle at which the electromagnetic radiation is received by the receiver, and therefore can infer the angle 630 at which the reflecting surface 624b is orientated. Thus, the control electronics can identify the article 610 in the receptacle 612 based on a spatial property of the electromagnetic radiation.

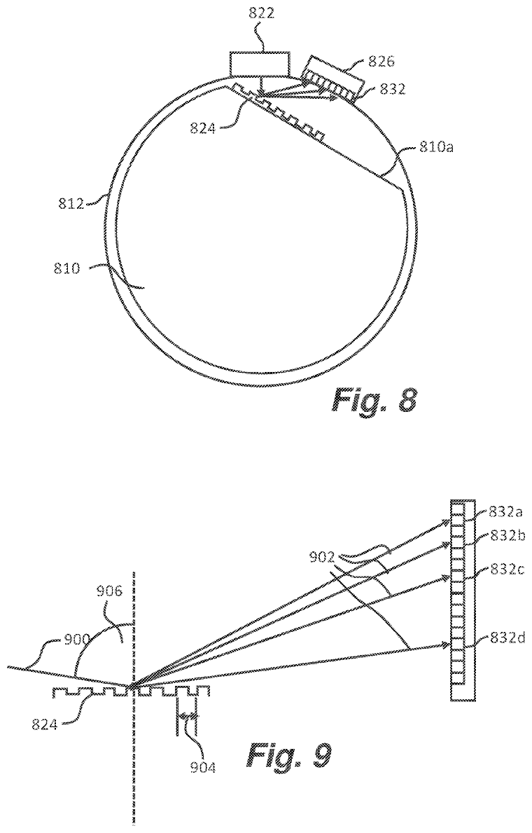

FIG. 8 depicts a third example arrangement to determine at least one characteristic of an article 810 based on a spatial property of electromagnetic radiation. FIG. 8 shows a top down view of the article 810 inserted into the device 100. Although the receptacle 812 has a circular cross-section, it will be appreciated that the receptacle 812 may have any shape cross-section.

The device 100 comprises an emitter 822, a receiver 826, and a receptacle 812. The receiver 826 comprises a single image sensor, which comprises a plurality of photodiodes 832. In this example the emitter 822 and the receiver 826 are arranged around a longitudinal axis of the receptacle 812, however in other examples they may be arranged vertically along the longitudinal axis of the receptacle 812. The receiver 826 may be communicably coupled to the control electronics 116 of the device 100 (shown in FIG. 3).

The article 810 comprises a component 824 arranged along an outer surface 810a of the article. In this example, the component 824 is a grating surface 824 configured to change the intensity distribution of electromagnetic radiation. For example, the emitter 822 emits electromagnetic radiation, which has a first intensity distribution, such as a point-like intensity distribution, onto the grating surface 824. The grating surface 824 interacts with the electromagnetic radiation to cause the electromagnetic radiation to have a second, different intensity distribution.

The grating surface 824 may be a rough surface, or a diffraction grating, for example. The rough surface may be provided by a material which fully or partially covers the outer surface 810a of the article. In this example, the grating surface 824 is a reflective diffraction grating.

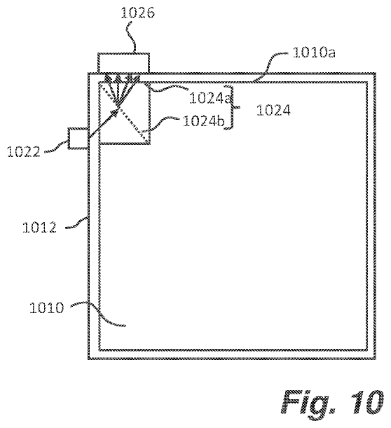

The grating surface 824 comprises raised protrusions (shown most clearly in FIG. 9) separated by a certain distance 904, which scatter and diffract incident electromagnetic radiation 900. The diffracting electromagnetic radiation waves undergo constructive and destructive interference such that the resultant electromagnetic radiation 902 has an intensity distribution comprising regions of higher and lower intensity. This intensity distribution may be known as a diffraction pattern. Thus, the grating surface 824 interacts with the incident electromagnetic radiation 900 to change the intensity distribution to that of the diffracted electromagnetic radiation 902.

The intensity distribution has a form which is dependent upon the spacing 904 between the protrusions, the angle of incidence 906 of the incident electromagnetic radiation 900, and the wavelength of the incident electromagnetic radiation 900. Articles 810 of a particular type can comprise a particular grating surface 824. Accordingly, the intensity distribution can be used as a signature to identify the article 810. By varying the spacing 904 and/or the angle of incidence 906 (by varying the orientation of the grating surface 824 with respect to the incident electromagnetic radiation 900), different intensity distributions can be created.

The spacing between the maxima and minima in the intensity distribution can be used to classify an intensity distribution. Accordingly, these may be measured and compared to the spacings between maxima and minima in known intensity distributions. If the measured intensity distribution matches a known intensity distribution, the article can be identified.

In a particular example, certain photodiodes 832a, 832b, 832c, 832d detect high intensity regions in the intensity distribution when compared to neighboring photodiodes. A different grating surface 824 and/or a different angle of incidence 906 would alter the locations and/or spacing between neighboring maxima. Accordingly, the measured intensity distribution can be compared to known intensity distributions to determine the type of article 810 present in the receptacle 812.

FIG. 10 depicts a fourth example arrangement to determine at least one characteristic of an article 1010 based on a spatial property of electromagnetic radiation. FIG. 10 shows a top down view of the article 1010 inserted into the device 100. Although the article 1010 has a square cross-section, it will be appreciated that the article 1010 may have any shape cross-section.

The device 100 comprises an emitter 1022, a receiver 1026, and a receptacle 1012. The receiver 1026 comprises a single image sensor, which comprises a plurality of photodiodes (not shown). In this example the emitter 1022 and the receiver 1026 are arranged around a longitudinal axis of the receptacle 1012, however in other examples they may be arranged vertically along the longitudinal axis of the receptacle 1012. The receiver 1026 may be communicably coupled to the control electronics 116 of the device 100 (shown in FIG. 3).

The article 1010 comprises a component 1024 arranged at an outer surface 1010a of the article. In this example, the component 1024 comprises a transparent surface 1024a which extends in two dimensions around a corner of the article 1010. The transparent surface 1024a forms a portion of the outer surface 1010a of the article 1010. The component 1024 further comprises a grating surface 1024 configured to change the intensity distribution of electromagnetic radiation. In this example, the grating surface 1024 is a transmissive diffraction grating.

The grating surface 1024 comprises two or more slits separated by a certain distance, which cause incident electromagnetic radiation to diffract and produce an intensity distribution comprising regions of higher and lower intensity.

The intensity distribution has a form which is dependent upon the spacing between the slits, the angle of incidence of the incident electromagnetic radiation, and the wavelength of the incident electromagnetic radiation. In the same way as described in relation to FIGS. 8 and 9, the intensity distribution can be used to identify the article 1010.

In some examples, the receivers in FIGS. 8 and 9 may comprise a plurality of image sensors. The intensity distribution may be determined by analyzing the intensity of the electromagnetic radiation received by each of the plurality of image sensors (in a similar way as described above for the plurality of photodiodes). For example, certain image sensors may be positioned so as to detect a high intensity maxima and other image sensors may be positioned so as to detect a low intensity minima.

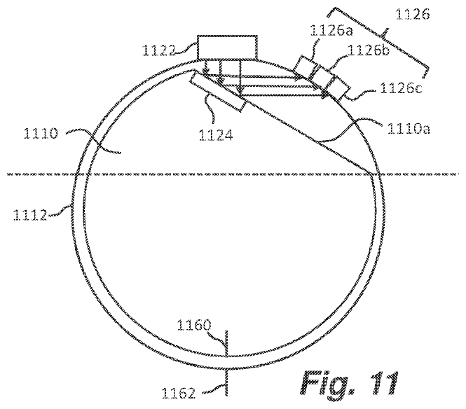

FIG. 11 depicts a fifth example arrangement to determine at least one characteristic of an article 1110 based on a spatial property of electromagnetic radiation. FIG. 11 shows a top down view of the article 1110 inserted into the device 100.

The device 100 comprises an emitter 1122, a receiver 1126, and a receptacle 1112. The emitter 1122 emits electromagnetic radiation having an initial polarization state, such as a circular polarization, a linear polarization, an elliptical polarization or no polarization, for example. The polarization state may further have a defined direction, such as left/right hand circular polarization, vertically/diagonally/horizontally linearly polarization, etc.

The receiver 1126 comprises a plurality of image sensors, including a first image sensor 1126a, a second image sensor 1126b and a third image sensor 1126c. In this example there are three image sensors, however it will be appreciated that the receiver 1126 may comprise two or more image sensors. In this example, the plurality of image sensors are arranged circumferentially around the receptacle 1112, however in other examples the plurality of image sensors may be arranged vertically, along a longitudinal axis of the receptacle 1112. The receiver 1126 may be communicably coupled to the control electronics 116 of the device 100 (shown in FIG. 3).

In this example, each image sensor of the plurality of image sensors comprises a filter which allows electromagnetic radiation to pass through if it has a particular polarization state. For example, the first image sensor 1126a may comprise a first filter which allows electromagnetic radiation to pass through if it has a first polarization state. The second image sensor 1126b may comprise a second, different, filter which allows electromagnetic radiation to pass through if it has a second polarization state. The third image sensor 1126c may comprise a third, different, filter which allows electromagnetic radiation to pass through if it has a third polarization state. In such an arrangement, the emitter 1122 may be configured to emit a wide beam of electromagnetic radiation such that the electromagnetic radiation is incident upon the first, second and third filters after interaction with a component 1124 on the article 1110.

The article 1110 comprises the component 1124 arranged along an outer surface 1110a of the article. In this example, the component 1124 is a polarization element, such as a lens or filter, configured to change the polarization state of the incident electromagnetic radiation.

The polarization element 1124 is arranged to receive incident electromagnetic radiation which has an initial polarization state, and then interact with the radiation to change the polarization state to a second, different polarization state which is received by the receiver 1126. The receiver 1126 therefore receives electromagnetic radiation with the second polarization state which depends on the specific characteristics of the polarization element 1124. If the polarization element 1124 was different, the receiver 1126 may have received electromagnetic radiation with a different polarization state. Accordingly, the polarization state of the received electromagnetic radiation can be used as a signature to identify the article 1110.

As mentioned, the electromagnetic radiation is incident upon the first, second and third filters of the first, second and third image sensors 1126a, 1126b, 1126c. In a particular example, the electromagnetic radiation arriving from the polarization element 1124 has a first polarization state and the first filter allows electromagnetic radiation to pass through which has a polarization state corresponding to the first polarization state. Thus, the first image sensor 1126a can receive and detect the electromagnetic radiation. In contrast, the second and third filters allow electromagnetic radiation to pass through which have a polarization state corresponding to a second and third polarization state respectively. Thus, the second and third image sensors 1126b, 1126c do not receive and detect the electromagnetic radiation. Accordingly, the control electronics can determine, based on the intensity of the electromagnetic radiation received by each of the plurality of sensors, the polarization state. For example, it may be assumed that the image sensor which records the highest intensity has a polarization filter which matches that of the electromagnetic wave.

In a particular example, the receiver 1126 measures the intensity of electromagnetic radiation received by each of the plurality of image sensors and sends sensor data to the control electronics 116 of the device 100. From the sensor data, the control electronics can determine or deduce the polarization state of the electromagnetic radiation received by the receiver, and therefore can identify the specific component 1124 of the article 1110. Thus, the control electronics can identify the article 1110 in the receptacle 412 based on a spatial property of the electromagnetic radiation.

In a similar example (not depicted), the receiver comprises a single sensor, such as an image sensor, for example. The image sensor comprises a plurality of photodiodes each having an associated polarization filter. The control electronics are configured to determine, based on which of the plurality of photodiodes receive the electromagnetic radiation, the polarization state. Thus, certain photodiodes may only detect electromagnetic radiation if the associated polarization filter allows that particular polarization state to pass through. For example, electromagnetic radiation may be incident upon the plurality photodiodes with a first polarization state. A first polarization filter may allow the electromagnetic radiation to pass through so that a first photodiode detects the electromagnetic radiation, and a second filter may filter out the electromagnetic radiation so that a second photodiode does not detect the electromagnetic radiation. Thus, based on which photodiode detects electromagnetic radiation, the polarization state can be determined.

In some examples (not depicted), the polarization element is a lens, which allows electromagnetic radiation to pass through the lens. The component further comprises a reflecting surface arranged inwardly of the lens. Accordingly, the radiation can pass through the lens so as to change the polarization state and is reflected from the reflecting surface, back through the lens (or through another transparent element), before being received by the receiver.

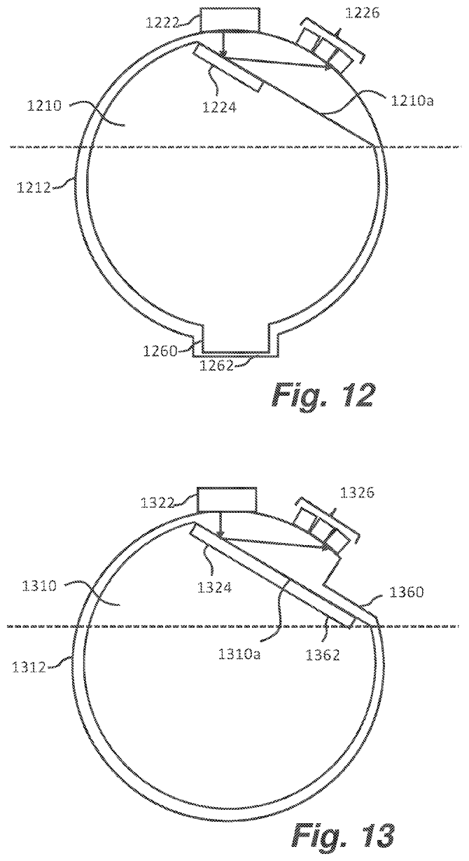

FIG. 12 depicts an example arrangement with an article 1210 comprising an alignment feature 1260 and a receptacle 1212 comprising a corresponding alignment feature. FIG. 12 shows a top down view of the article 1210 inserted into the device 100. Although the article 1210 is depicted with a particular cross-section, having one degree of rotational symmetry, it will be appreciated that the article 1210 may have any shape cross-section, such as other shapes with one degree of rotational symmetry or two, three, four or more degrees of rotational symmetry.

The device 100 comprises an emitter 1222, a receiver 1226, and a receptacle 1212. The article 1210 comprises a component 1224 arranged along an outer surface 1210a of the article which must be correctly orientated with respect to the emitter 1222 and receiver 1226. To achieve this, the receptacle 1212 of the device comprises an alignment feature 1262 to interact with a corresponding alignment feature 1260 of the article 1210. This ensures that the article 1210 is received within the receptacle 1212 at a predetermined orientation relative to the emitter/receiver. Where the article has two or more degrees of rotational symmetry a corresponding number of components may be provided positioned so that a component is at the correct orientation to the emitter 1222 and receiver 1226 however the article is oriented.

The alignment feature 1260 of the article 1210 is defined by the outer surface 1210a of the article, and may take any form. In this example, the article 1260 has an asymmetric cross-section. Similarly, the alignment feature 1262 of the receptacle 1212 is defined by the inner surface of the receptacle 1210.

In some examples, the receptacle and/or article comprises two or more alignment features which allows the article to be inserted at two or more predetermined orientations. In such an example, the article may therefore comprise two or more components arranged at the outer surface of the article, where the component is configured to interact with electromagnetic radiation to change a spatial property of the electromagnetic radiation. This means that the user has more freedom to insert the article and at least one of the components will still be correctly aligned with the emitter and receiver.

FIG. 13 depicts another example arrangement with an article 1310 comprising an alignment feature 1360 and a receptacle 1312 comprising a corresponding alignment feature. FIG. 13 shows a top down view of the article 1310 inserted into the device 100. Although the article 1310 has a circular cross-section, it will be appreciated that the article 1310 may have any shape cross-section.

The device 100 comprises an emitter 1322, a receiver 1326, and a receptacle 1312. The article 1310 comprises a component 1324 arranged along an outer surface 1310a of the article which must be correctly orientated with respect to the emitter 1322 and receiver 1326. The component may be a reflecting surface, a polarization element, a transparent surface, or a grating surface, for example. To achieve the correct orientation and alignment, the receptacle 1312 of the device comprises an alignment feature 1362 to interact with a corresponding alignment feature 1360 of the article 1310. This ensures that the article 1310 is received within the receptacle 1312 at a predetermined orientation relative to the emitter/receiver. In this example, the reflecting surface, the polarization element, the transparent surface, or the grating surface forms the alignment feature (to cooperate with the corresponding alignment feature 1360 of the receptacle 1312).

In one example (illustrated in FIG. 11), the alignment features are visual markers to inform the user how to insert the article 1110, rather than being a physical feature which limits the insertion. FIG. 11 shows a first marker 1160 present on the article 1110, and a second marker 1162 present on the device. The user must align these two markers otherwise the receiver 1126 may not detect any electromagnetic radiation signal. In absence of any signal, the device may cease to operate, and the user may be notified to check that the markers are correctly aligned.

In some examples, the above described identification methods can be used in combination with other identification methods. For example, a coating or component on the article is configured to alter the wavelength of reflected electromagnetic radiation in a specific way which can be used to identify the article. For example, the coating or component may absorb particular wavelengths of incident electromagnetic radiation and by measuring the wavelengths of the reflection, the identity of the consumable can be determined. Alternatively, the coating or component may alter the incident electromagnetic radiation to introduce wavelengths not present in the incident radiation (i.e. via fluorescence). When fluorescence techniques are used, the decay in the fluorescence can also be measured and used to form part of the identification of the article.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An aerosol provision device comprising:
a receptacle configured to receive an article comprising an aerosolizable medium;
an emitter configured to emit electromagnetic radiation into the receptacle;
a receiver configured to receive the electromagnetic radiation after the electromagnetic radiation interacts with the article in the receptacle; and
control electronics configured to determine at least one characteristic of the article based on a spatial property of the electromagnetic radiation received by the receiver.

2. The aerosol provision device according to claim 1, wherein the spatial property is an angle at which the electromagnetic radiation is received by the receiver.

3. The aerosol provision device according to claim 2, wherein the receiver comprises an image sensor, and wherein the control electronics are configured to determine, based on the received electromagnetic radiation at the image sensor, the angle at which the electromagnetic radiation is received.

4. The aerosol provision device according to claim 2, wherein the receiver comprises a plurality of image sensors and wherein the control electronics are configured to determine, based on which of the plurality of image sensors receives the electromagnetic radiation, the angle at which the electromagnetic radiation is received.

5. The aerosol provision device according to claim 1, wherein the spatial property is an intensity distribution of the electromagnetic radiation.

6. The aerosol provision device according to claim 5, wherein the receiver comprises an image sensor, and wherein the control electronics are configured to determine, based on the received electromagnetic radiation at the image sensor, the intensity distribution.

7. The aerosol provision device according to claim 5, wherein the receiver comprises a plurality of image sensors and wherein the control electronics are configured to determine, based on an intensity of the electromagnetic radiation received by each of the plurality of image sensors, the intensity distribution.

8. The aerosol provision device according to claim 1, wherein the spatial property is a polarization state of the electromagnetic radiation.

9. The aerosol provision device according to claim 8, wherein the receiver comprises a sensor and wherein the control electronics are configured to determine, based on the received electromagnetic radiation, the polarization state.

10. The aerosol provision device according to claim 8, wherein the receiver comprises a plurality of sensors each configured to receive electromagnetic radiation of a particular polarization state, and wherein the control electronics are configured to determine, based on an intensity of the electromagnetic radiation received by each of the plurality of sensors, the polarization state.

11. The aerosol provision device according to claim 1, further comprising a heating assembly, wherein the control electronics are configured to operate the heating assembly based on the determined at least one characteristic of the article.

12. The aerosol provision device according to claim 1, further comprising an alignment feature to ensure that the article is received within the receptacle at a predetermined orientation relative to the emitter.

13. An article comprising:
an aerosolizable medium; and
a component arranged at an outer surface of the article, wherein the component is configured to interact with electromagnetic radiation to change a spatial property of the electromagnetic radiation.

14. The article according to claim 13, wherein the component comprises a reflecting surface orientated at predetermined angle, and the spatial property is an angle at which the electromagnetic radiation is deflected by the reflecting surface.

15. The article according to claim 14, wherein the reflecting surface forms at least a portion of the outer surface of the article.

16. The article according to claim 14, wherein the component further comprises a transparent surface through which the electromagnetic radiation can pass, and wherein the transparent surface forms at least a portion of the outer surface of the article and the reflecting surface is positioned inwardly of the transparent surface.

17. The article according to claim 13, wherein the spatial property is an intensity distribution of the electromagnetic radiation, and wherein the component comprises a grating surface configured to change the intensity distribution of the electromagnetic radiation.

18. The article according to claim 17, wherein the component forms at least a portion of the outer surface of the article, and the component has a predetermined surface roughness to form the grating surface.

19. The article according to claim 13, wherein the spatial property is a polarization state of the electromagnetic radiation, and wherein the component comprises a polarization element configured to change the polarization state of the electromagnetic radiation.

20. The article according to claim 13, wherein the outer surface of the article comprises an alignment feature to ensure that the article is positioned within an aerosol provision device at a predetermined orientation.

21. A system comprising:
the aerosol provision device according to claim 1; and
the article comprising:
the aerosolizable medium, and
a component arranged at an outer surface of the article, wherein the component is configured to interact with the electromagnetic radiation to change the spatial property of the electromagnetic radiation.
